(19) United States
(12) Patent Application Publication
(10) Pub. No.: US 2026/0103913 A1
(43) Pub. Date: Apr. 16, 2026

(54) POST SUPPORT UNIT

(71) Applicant: ICE CHALLENGE ENTERPRISES, LLC, Edmond, OK (US)

(72) Inventor: Dmitri Logoutine, Edmond, OK (US)

(73) Assignee: ICE CHALLENGE ENTERPRISES, LLC, Edmond, OK (US)

(21) Appl. No.: 18/914,662

(22) Filed: Oct. 14, 2024

(51) Int. Cl. E04H 12/22; F21S 8/08

(52) U.S. Cl. CPC E04H 12/2238; F21S 8/086

(57) ABSTRACT

A post support unit has an upper block with an upper block top surface and an upper block bottom surface. An upper block notch is defined in the upper block. The post support unit has a lower block with a lower block top surface and a lower block bottom surface with a lower block notch defined in the lower block and engaged with the upper block notch. A hollow pipe defining a post receiving opening is fixed to the upper block.

### FIELD

The field relates to post supports for supporting vertical posts in different settings.

### BRIEF DESCRIPTION OF THE DRAWINGS

FIG. 1 is a perspective view of a post support unit.

FIG. 2 is an exploded view of the post support unit.

FIG. 3 is a cross section of a first block of the post support unit.

FIG. 4 is a cross section of a second block of the post support unit.

FIG. 5 is a perspective view of a post support unit with a sitting bench supported thereby.

FIG. 6 is an elevation view of the support post unit with a post extending upwardly therefrom.

FIG. 7 is a close-up view of an anchor fixed to the post support unit.

### SUMMARY

The current disclosure is directed to a post support unit for an upright or vertical post. The current disclosure is also directed to a post assembly that includes a post support unit with an upright or vertical post supported thereby. The post support unit is heavy enough to support a light, or other post that may be used outside in windy conditions. For example, the post support unit may be used at temporary event or activity sites, such as a temporary outdoor ice rink that is often set up in the wintertime months. The post support unit may comprise interlocking first and second, or upper and lower interlocking support blocks. The interlocking first and second support blocks are separable so that each can be moved independently of the other.

The upper and lower support blocks have notches to interlock and assemble into a post support unit. The upper support block has a notch in a lower surface thereof and the lower support block has a notch in the upper surface thereof to engage the notch in the upper support block. The post support unit has a post receiving opening, which may be defined by a hollow pipe that is fixed in one of the upper and lower support blocks, and in the current disclosure is in the upper support block. An upright post, such as a light post with lights thereon, is inserted into the post receiving opening and is supported by the post support unit. A plurality of anchors is fixed in the support unit, and securement lines are attached to the anchors, and to the upright post to stabilize the post.

### DESCRIPTION OF AN EMBODIMENT

In the drawings and description that follow, like parts are typically marked throughout the specification and drawings with the same reference numerals, respectively. In addition, similar reference numerals may refer to similar components in different embodiments disclosed herein. The drawing figures are not necessarily to scale. Certain features may be shown exaggerated in scale or in somewhat schematic form and some details of conventional elements may not be shown in the interest of clarity and conciseness. Specific embodiments are described in detail and are shown in the drawings, with the understanding that the present disclosure is not intended to be limited to the embodiments illustrated and described herein. It is to be fully recognized that the different teachings of the embodiments discussed herein may be employed separately or in any suitable combination to produce desired results.

Unless otherwise specified, use of the terms “connect,” “engage,” “couple,” “attach,” or any other like term describing an interaction between elements is not meant to limit the interaction to direct interaction between the elements and may also include indirect interaction between the elements described.

As used herein, qualifiers like “substantially,” “about,” “approximately,” and combinations and variations thereof, are intended to include not only the exact amount or value that they qualify, but also some slight deviations therefrom, which may be due to manufacturing tolerances, measurement error, wear and tear, stresses exerted on various parts, and combinations thereof, for example.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition. The use of the term “at least one” or “one or more” will be understood to include one as well as any quantity more than one.

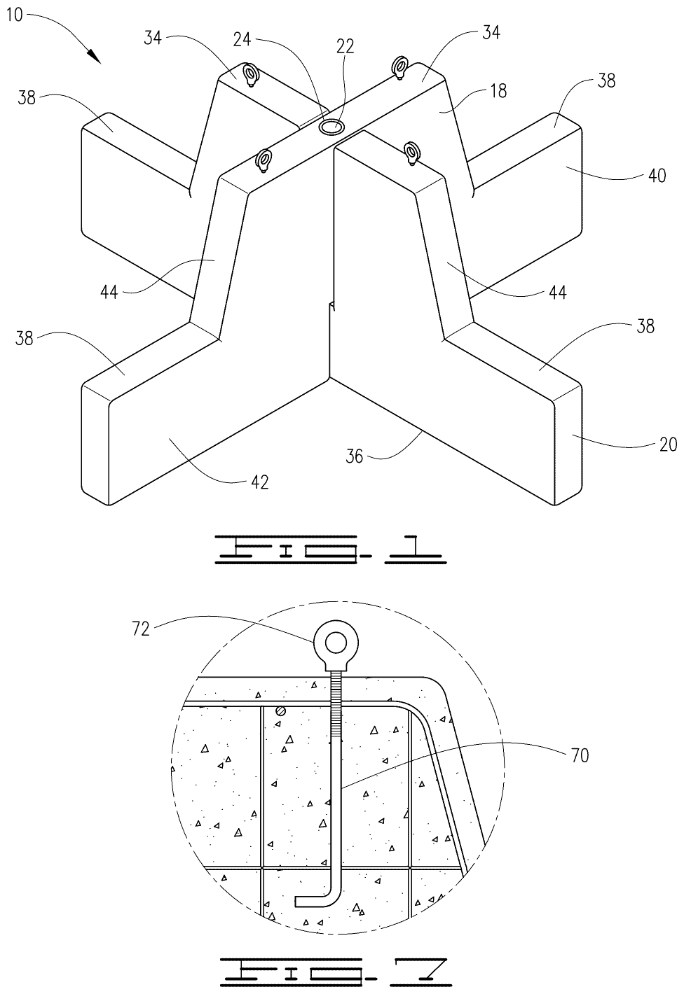

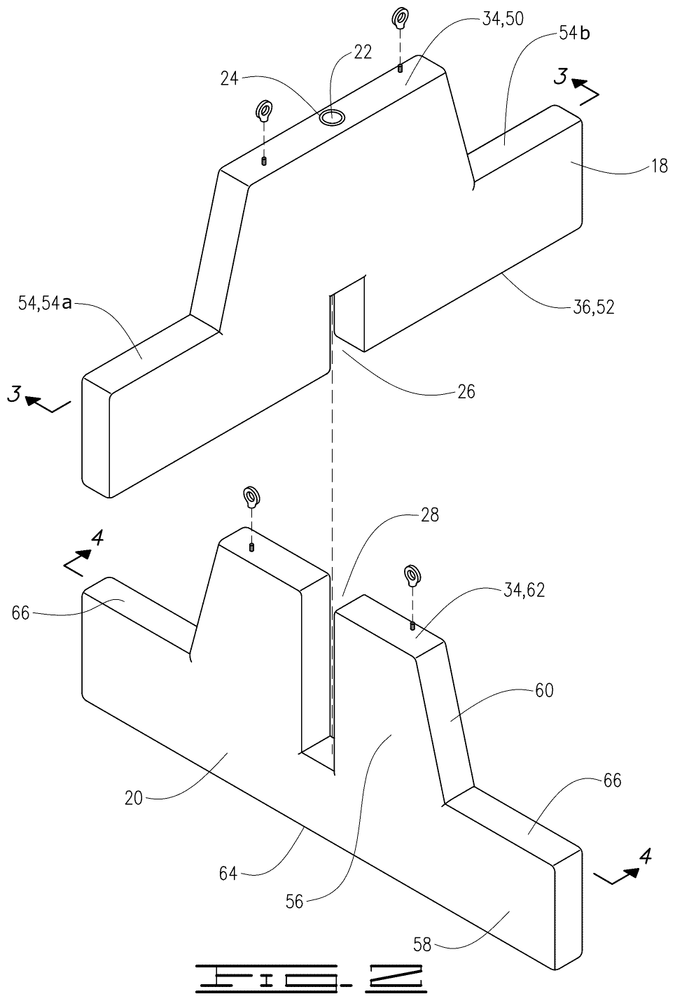

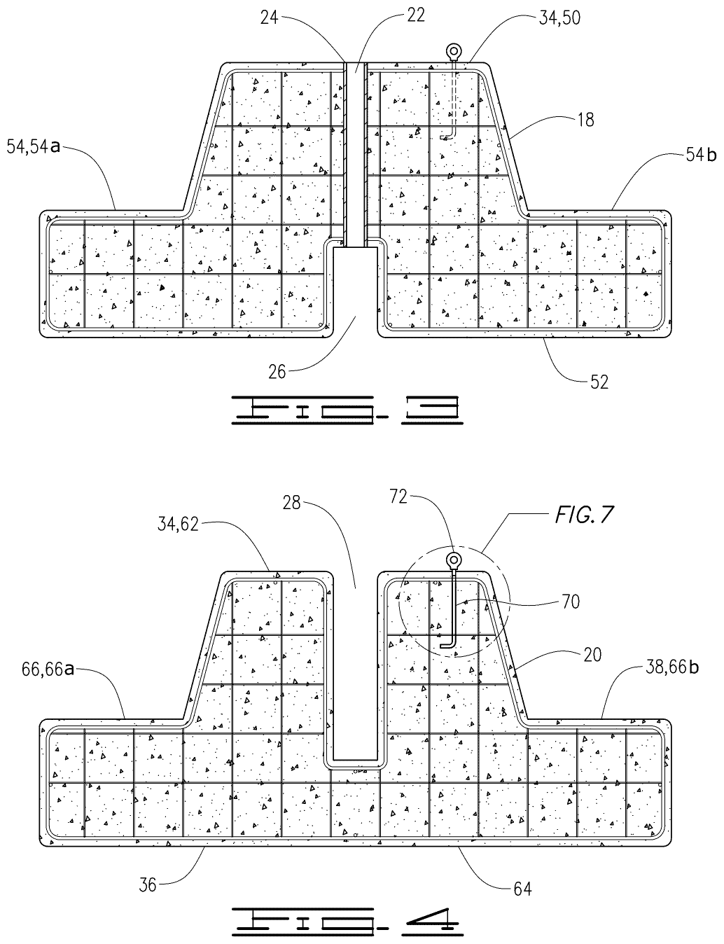

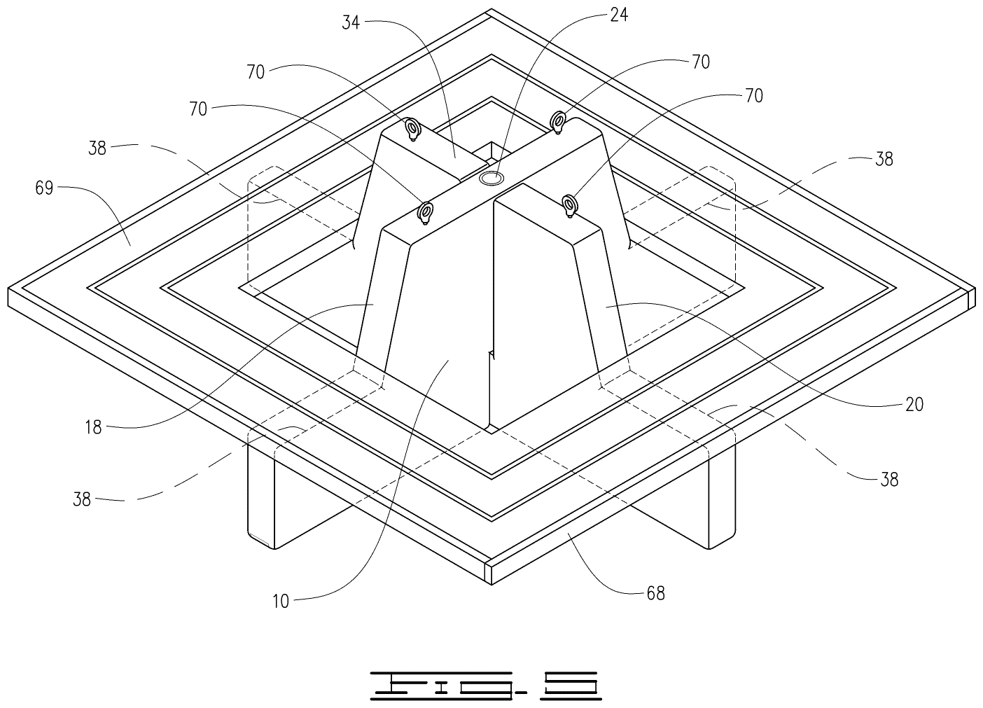

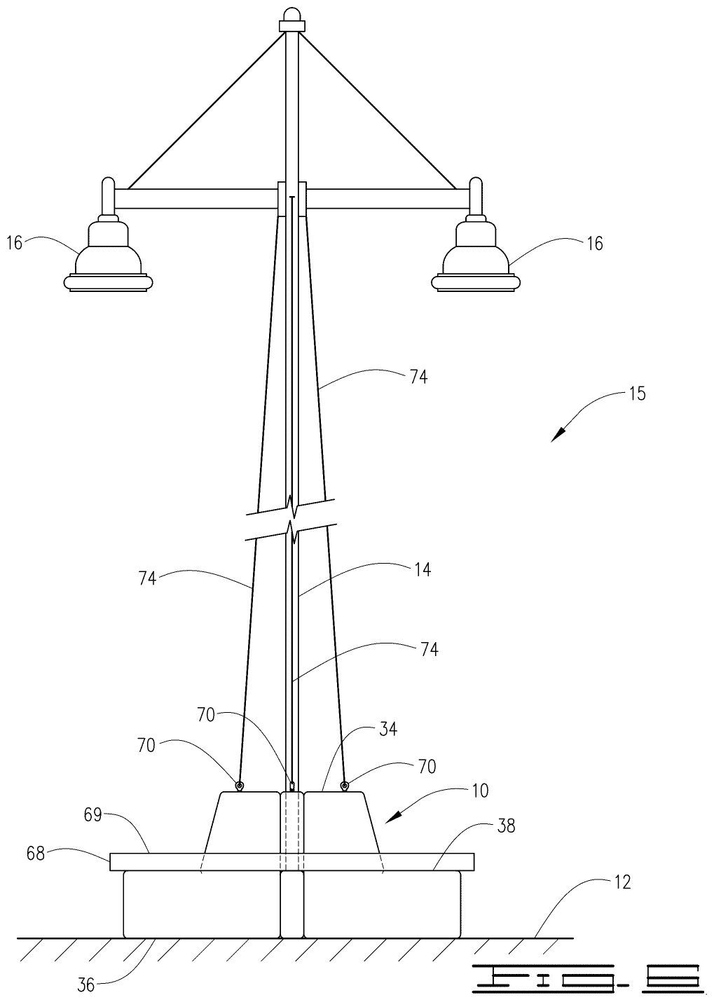

Referring now to FIG. 1, a post support unit 10 is shown. Post support unit 10 may be placed on a stable support surface 12, which in one embodiment is a ground surface 12. A post 14 extends from and is supported by post support unit 10. The post support unit 10 and post 14 may be referred to as a post assembly 15. Post 14 may be for example a light post with at least one light 16, and in some cases a plurality of lights 16. Post 14 may be other types of outdoor and indoor posts that must be able to remain upright without tipping or falling over even when exposed to wind or other forces. The post assembly 15 is usable in numerous environments, for example, at event and activity sites. Post support units 10 are transportable from one site to another, and can be placed at the desired site and lights placed therein to provide temporary lighting. One example is a temporary outdoor ice rink, but other indoor and outdoor uses are contemplated. Although movable and transportable, the post support unit 10 must have sufficient weight to adequately support tall posts. Post 14 will typically be at least 10 feet tall and may be as tall as thirty feet. Post support unit 10 will therefore have a weight sufficient to support posts of such height and will typically have a weight of several hundred pounds. To adequately provide a stable base, the weight of support unit 10 will typically be 500 pounds or more and will oftentimes be in the range of 1500 to 3000 pounds. As a result, a forklift or other lifting equipment is generally required to move the post support unit 10.

Post support unit 10 may comprise a first, or upper support block 18 and a second, or lower support block 20. First and second post support blocks 18 and 20 are interlocking support blocks that have sufficient weight to support posts exposed to wind and other tipping forces. Each of upper and lower support blocks 18 and 20 will have a weight of several hundred pounds, so that the combined weight is as set forth above. Upper and lower support blocks 18 and 20 must therefore be made from a material sufficient to generate the necessary weight. In one embodiment, the first and second support blocks 18 and 20 may be made from reinforced concrete as depicted in FIGS. 3 and 4. A post receiving opening 22 is defined in post support unit 10, and in the described embodiment is defined in upper support block 18. A hollow pipe 24 may be fixed in upper support block 18 and post receiving opening 22 may be defined in hollow pipe 24. Hollow pipe 24 may be comprised of metal or other pipe material that will resist wear.

Upper support block 18 has a notch 26 defined therein. Lower support block 20 is received in notch 26 in the assembled post support unit 10. Lower support block 20 has a notch 28 therein. Upper support block is received in notch 28 in the assembled post support unit 10. Upper and lower support blocks 18 and 20 interlock when assembled into the post support unit 10. Post support unit 10 has support unit top surface 34, support unit bottom surface 36 and a support unit intermediate upward facing surface 38 between support unit top and bottom surfaces 34 and 36. Support unit intermediate surface 38 is in one embodiment substantially parallel to the stable support surface 12. Support unit intermediate surface 38 may also be parallel to support unit top surface 34.

Upper support block 18 has upper portion 40, lower portion 42 and sloped surfaces 44 that transition from upper portion 40 to lower portion 42. In the current disclosure, the upper portion 40 of upper support block 18 is generally trapezoidal, and lower portion 42 of upper support block 18 is rectangular. Upper support block 18 has top surface 50, bottom surface 52 and intermediate upward facing surface 54 between top surface 50 and bottom surface 52. Top surface 50 of upper support block 18 comprises a portion of support unit top surface 34, bottom surface 52 of upper support block 18 comprises a portion of support unit bottom surface 36, and intermediate surface 54 of upper support block 18 comprises a portion of support unit intermediate surface 38. Upper support block intermediate surface 54 is comprised of substantially parallel flat co-planar surfaces 54a and 54b that are separated by upper portion 40 of upper support block 18. Upper block intermediate surface 54 is in one embodiment substantially parallel to upper support block bottom surface 52 and may be parallel to upper block top surface 50. Notch 26 extends upwardly from upper support block bottom surface 52.

Lower support block 20 has upper portion 56, lower portion 58 and sloped surfaces 60 that transition from upper portion 56 to lower portion 58. In the current disclosure, the upper portion 56 of lower support block 20 is generally trapezoidal, and lower portion 58 of lower support block 20 is rectangular. Lower support block 20 has top surface 62, bottom surface 64 and intermediate upward facing surface 66 between top surface 62 and bottom surface 64. Top surface 62 of lower support block 20 comprises a portion of support unit top surface 34, bottom surface 64 of lower support block 20 comprises a portion of support unit bottom surface 36, and intermediate surface 66 of lower support block 20 comprises a portion of support unit intermediate surface 38. Lower support block intermediate surface 66 is comprised of substantially parallel flat co-planar surfaces 66a and 66b that are separated by upper portion 56 of lower support block 20. Lower support block intermediate surface 66 is in one embodiment substantially parallel to lower support block bottom surface 64 and may be parallel to lower support block top surface 62. Notch 28 extends upwardly from lower block bottom surface 64.

Upper support block intermediate surface 54 and lower support block intermediate surface 66 are substantially flat, coplanar surfaces and provide a support surface for a bench, such as a sitting bench 68. Bench 68 may have a flat upper surface 69 that provides a place for event and activity goers to sit and/or place personal items. Anchors 70 with an attachment hook 72 for attaching a securement line 74 thereto are fixed to post support unit 10. Anchors 70 may be placed in one, or both of upper and lower support blocks 18 and 20, and in the described embodiment two anchors are positioned in each. Attachment hook 72 can take the form of a hook, eyelet, or any other shape to which a line can be connected. Securement lines 74 are connected to anchors 70 and to post 14 as shown in FIG. 6 to stabilize and support the post 14.

Base support unit 10 is particularly useful in outdoor settings in which tall posts of up to 30 feet may be needed, and where posts may support other features such as lights. The materials from which upper and lower support blocks 18 and 20 are made will be heavy so that the post support unit 10 will have sufficient weight to hold posts 14 in place and prevent tipping or falling. Post support unit 10 may weigh for example as much as 3000 pounds. The upper and lower support blocks 18 and 20 are separable and designed to be movable from one site to another for use in various locations. For example, seasonally prepared locations, such as temporary ice rinks in the wintertime, are constructed in various locations. Such locations need lighting so that nighttime use is possible. The post support units 10 of the current disclosure can be moved from place to place to provide a stable support for light posts or other posts at any desired location. Although the support units are movable, the weight of the upper and lower support blocks 18 and 20 is such that a forklift, or other lifting equipment will be needed to move the post support units 10.

Thus, it is seen that the apparatus and methods of the present invention readily achieve the ends and advantages mentioned as well as those inherent therein. While certain preferred embodiments of the invention have been illustrated and described for purposes of the present disclosure, numerous changes in the arrangement and construction of parts and steps may be made by those skilled in the art, which changes are encompassed within the scope and spirit of the present invention.

What is claimed is:

1. A post support unit comprising:
an upper block having an upper block top surface and an upper block bottom surface, an upper block notch being defined in the upper block;
a lower block having a lower block top surface and a lower block bottom surface, a lower block notch defined in the lower block and engaged with the upper block notch, both of the upper and lower block bottom surfaces being in contact with a stable support surface when the notches are engaged; and
a hollow pipe fixed to the upper block defining a post receiving opening.

2. The post support unit of claim 1, the upper and lower blocks comprising concrete blocks.

3. The post support unit of claim 1, further comprising first and second stabilizing line anchors in at least one of the upper and lower blocks.

4. The post support unit of claim 3, further comprising:
a post inserted into the post receiving opening and extending upwardly therefrom; and
a stabilizing line connected to each of the first and second stabilizing line anchors to the post.

5. The post support unit of claim 4, the post comprising an outdoor light post with at least one light attached thereto.

6. The post support unit of claim 1, the upper block having an intermediate surface between the upper block top and bottom surfaces and the lower block having a lower block intermediate surface between the lower block top and bottom surfaces, the upper block intermediate surface and the lower block intermediate surface comprising substantially parallel flat coplanar surfaces that are parallel to the lower block bottom surface.

7. The post support unit of claim 6, further comprising a seating platform supported by the upper block support surfaces and the lower block support surfaces.

8. A post assembly comprising:
first and second interlocking support blocks, the first and second support blocks being comprised of reinforced concrete and positioned on a stable support surface;
a hollow pipe fixed in the first support block; and
a post inserted into the hollow pipe and extending upwardly from the first support block.

9. The post assembly of claim 8, the first and second interlocking support blocks having substantially the same peripheral shape, the first support block defining a notch in the bottom surface thereof, the second support block having a notch in the upper surface thereof, the second block being received in the notch in the first block.

10. The post assembly of claim 8, the first and second interlocking support blocks comprising a post support unit, the post support unit having a post support unit bottom surface, wherein substantially all of the post support unit bottom surface engages the stable support surface.

11. The post assembly of claim 8, the post comprising a light post having a height of at least ten feet above the upper surface of the first support block.

12. The post assembly of claim 11, the post comprising a rigid post having at least one light mounted thereon.

13. The post assembly of claim 10, the post support unit having a cross-shaped footprint.

14. The post assembly of claim 10, the post support unit having a post support unit top surface and having a sitting bench support surface between the post support unit top and bottom surfaces, the bench support surface substantially parallel to the post support unit bottom surface.

15. The post assembly of claim 8, the first and second support blocks having a combined weight of at least 1000 pounds.

16. A post assembly comprising:
a first support block having a first support block top surface and a first support block bottom surface, the first support block top surface having a post receiving opening defined therein;
a second support block having a second support block top surface and a second support block bottom surface, the first and second support blocks having first and second interlocking notches, the first support block being received in the second support block notch and the second support block being received in the first support block notch;
anchors securely fixed in at least one of the first and second support blocks;
a post inserted in the post receiving opening and extending above the top surfaces of the first and second support blocks; and
securement lines connected to the anchors and to the post.

17. The post assembly of claim 16, further comprising a sitting bench supported by the first and second support blocks.

18. The post assembly of claim 16, the first support block defining a first support block intermediate surface between the first support block top and bottom surfaces, the second support block defining a second support block intermediate surface between the second support block top and bottom surfaces, the first and second block intermediate surfaces being substantially co-planar and substantially parallel to the first and second support block bottom surfaces, the sitting bench being supported by the first and second support block intermediate surfaces.

19. The post support of claim 16, further comprising a hollow pipe fixed in the first support block, the hollow pipe defining the post receiving opening.

20. The post support of claim 16, the first and second support blocks comprised of reinforced concrete and having a combined weight of at least 1000 pounds.
